(19) United States
(12) Patent Application Publication
(10) Pub. No.: US 2018/0216466 A1
(43) Pub. Date: Aug. 2, 2018

(54) METHODS AND SYSTEMS FOR ROTATING COMPONENT BALANCING

(71) Applicant: PW Power Systems, Inc., Glastonbury, CT (US)

(72) Inventor: Kenneth Heyden, Vernon, CT (US)

(21) Appl. No.: 15/293,774

(22) Filed: Oct. 14, 2016

(51) Int. Cl. F01D 5/02; G01M 1/24; F16F 15/32; G01M 13/02

(52) U.S. Cl. CPC F01D 5/027; G01M 13/025; F16F 15/322; G01M 1/24

(57) ABSTRACT

The subject matter of the present disclosure can help provide solutions to problems associated with eccentricities between mounting components in rotating gas turbine engine components, such as by providing a simulator component for balancing with an actual component outside of a gas turbine engine installation. The simulator component can allow for balancing of the actual component cumulatively with the simulator component for later installation of the actual component into a gas turbine engine with a simulated component simulated by the simulator component. The simulator component can have rotational dynamic properties, e.g., the same center of gravity and a scaled diametral moment of inertia, relative to the simulated component.

### TECHNICAL FIELD

The present application pertains generally, but not by way of limitation, to gas turbine engines. More particularly, the present application is directed to, but not by way of limitation, methods and systems for balancing rotating components in a gas turbine engine.

### BACKGROUND

Gas turbine engines operate by passing a volume of gases through a series of compressors and turbines in order to produce rotational shaft power. High energy gases rotate a turbine to generate the shaft power. The shaft power drives a compressor to provide compressed air to a combustion process that generates the high energy gases for turning the turbine. In an aircraft engine, the turbine can be used to generate propulsion, such as directly via thrust, or indirectly via a shaft and fan or propeller. In an industrial gas turbine, the shaft power can drive a generator that produces electricity. Alternatively, a power turbine can be used to drive a shaft for powering the generator.

Each compressor and turbine includes a plurality of stages of stator vanes (also known as nozzles or stators) and rotor blades (also known as buckets), each vane and blade including an airfoil. In general, vanes redirect the trajectory of the gas coming off the blades for flow into the next stage. In the compressor, vanes convert kinetic energy of moving gas into pressure, while, in the turbine, vanes accelerate pressurized gas to extract kinetic energy. In the compressor, the rotating blades push gas past the stationary vanes. In the turbine, the rotating blades extract rotational power from the flowing gas.

In order to assist the gas turbine engine in operating efficiently, it is important that the rotating components within a gas turbine engine rotate in a balanced manner. Balanced rotation of the gas turbine engine can reduce vibration, which can lead to improved component life, particularly for bearings and blade tips. As such, the rotating components of gas turbine engines are balanced upon manufacture and periodically rebalanced thereafter, such as during maintenance procedures and when rotating components are replaced. This process can typically involve attempting to balance rotating components, such as shafts, disks and blades, in the field. For ground-based industrial gas turbine systems, this can sometimes mean that the rotating components are inconveniently positioned within the power turbine or power generator. Furthermore, the components to be balanced in industrial gas turbine systems can be large and difficult to maneuver. For example, a typical industrial gas turbine rotor disk may weigh upwards of 10,000 pounds (˜4,500 kilograms).

Various methods and system for balancing rotating components are described in U.S. Pat. No. 6,962,080 to Robbins, U.S. Pat. No. 7,685,876 to Mollmann et al., and U.S. Pat. No. 8,567,060 to Calvert et al.

### OVERVIEW

The present inventors have recognized, among other things, that rotating components of gas turbine engines can sometimes be located and sized in such a manner that balancing those components can be difficult. Furthermore, when balancing replacement parts, it can sometimes be difficult to coordinate balancing of already installed components, such as a shaft, with a replacement component, such as a disk, or vice versa. For example, even if a power turbine rotor assembly and a power turbine shaft are independently balanced, the assembly may be unbalanced. This can arise because the power turbine rotor assembly and power turbine shaft are each balanced with respect to their own center of gravity, which is located relative to the centers of attachment interfaces for each component. However, the center of gravity of the power turbine shaft may not sufficiently be co-axially aligned with the center of gravity of the power turbine rotor assembly because manufacturing tolerances may not allow the center of attachment interfaces on the shaft to be co-axially aligned with the central axis of the shaft. In other words, eccentricities and/or angular misalignment of forward and rear attachment interfaces relative to the central axis of the shaft are often not corrected for when the shaft is balanced alone.

The subject matter of the present disclosure can help provide solutions to these and other problems, such as by providing a simulator component for balancing with an actual component outside of a gas turbine engine installation. An actual component balanced with the simulator component can allow for later installation of the actual component into a gas turbine engine with another actual component that had been simulated by the simulator component (i.e. a simulated component). The simulator component can have rotational dynamic properties, e.g., the same center of gravity and a scaled mass and/or diametral mass moment of inertia, relative to the simulated component.

In one example, a method of balancing a mounting eccentricity or misalignment between first and second rotating components of a gas turbine system can comprise: balancing a first rotating component apart from the second rotating component. The balanced first rotating component can comprise: a first body extending along a central axis, and a first attachment interface positioned at a first end portion of the body, the first attachment interface having a first center offset from the central axis. The method can further comprise: attaching a balanced first simulator to the first attachment feature. The first simulator can have: rotational dynamic properties located around a center point that are equivalent to rotational dynamic properties of the second rotating component, and simulator mass properties scaled from mass properties of the second rotating component. The method can further comprise: rotating the first rotating component and the first simulator together; determining a first simulator correction factor to apply to the gas turbine system to balance the first rotating component and the first simulator; and scaling the first simulator correction factor to determine a first actual correction factor to apply to the gas turbine system to balance the first rotating component and the second rotating component.

In another example, a method of balancing a rotor assembly for use with a gas turbine engine system can comprise: attaching a balanced simulator to a balanced shaft of the rotor assembly, the simulator having scaled mass properties and a scaled geometry of a rotor disk of the rotor assembly, and wherein a center of gravity of the simulator is known relative to a center of gravity of the rotor disk; determining unbalance of the shaft and simulator when rotating together as an assembly apart from the rotor disk; and calculating an un-scaled magnitude of a weight correction and a location for the weight correction on the shaft to offset vibration of the rotor disk when the weight correction is applied to the shaft.

In yet another example, a method of balancing a gas turbine rotor disk stack having rotor disks successively arranged from a first end for connecting to a shaft to a second end in a sequential direction from the first end can comprise: individually balancing each rotor disk of the rotor disk stack and individually rotating selective rotor disks with respective simulators, the respective simulators corresponding to any subsequent sequential rotor disks connected to the selective rotor disks in the sequential direction. Each simulator can comprise: a scaled mass and a scaled geometry of the subsequent sequential rotor disks, and a center of gravity that is equal to a center of gravity of the subsequent sequential rotor disks. The method can further comprise individually determining unbalance of each selective rotor disk and respective simulator; calculating an un-scaled magnitude of a weight correction and a location for the weight correction on end disks of the rotor disk stack to offset vibration of each selective rotor disk when the weight correction is applied to the rotor disk stack; and aggregating the weight corrections for each of the selective rotor disks for applying the weight corrections to prescribed locations in the rotor disk stack.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

FIG. 1 is a partially broken away side view of an industrial gas turbine engine showing a portion of a turbine section of a gas generator disposed between a combustor section and a power generator.

FIG. 2 is a schematic cross-sectional view of a rotor assembly of a power turbine of the gas generator of FIG. 1 showing a shaft coupled to a three-disk rotor stack.

FIG. 3 is a schematic cross-sectional view of the shaft of FIG. 2 coupled to a three-disk rotor stack simulator at a first end and a coupling shaft simulator at a second end.

FIG. 4 is a schematic view of the three-disk rotor stack of FIG. 2 showing locations for simulators for sequential balancing of each rotor disk.

FIG. 5A is a block diagram showing a method and process for balancing a rotating system, such as a power turbine shaft and rotor stack assembly.

FIG. 5B is a block diagram showing a method and process for balancing a rotating system, such as a plurality of rotor disks in a rotor stack.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

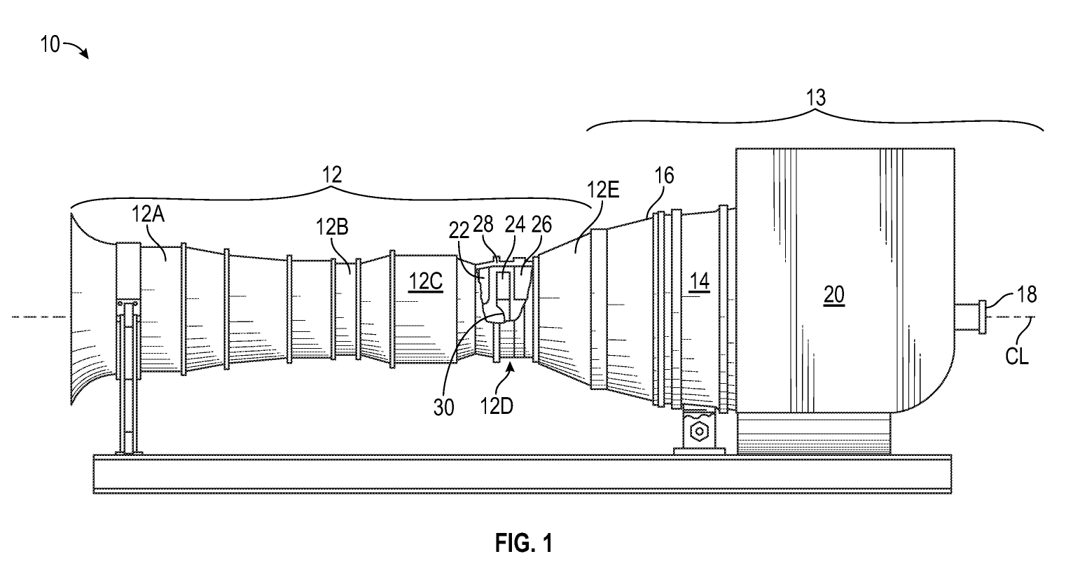

FIG. 1 is a partially broken away side view of gas turbine engine 10 showing gas generator 12 connected to power generator 13 via power turbine 16. In the illustrated embodiment, gas turbine engine 10 is an industrial gas turbine engine circumferentially disposed about a central, longitudinal axis or axial engine centerline CL. Gas generator 12 includes, in series order from front to rear, low pressure compressor section 12A, high pressure compressor section 12B, combustor section 12C, high pressure turbine section 12D, and low pressure turbine section 12E. Power generator 13 comprises power turbine 16, which is disposed aft of low pressure turbine section 12E, power turbine exhaust section 14, output shaft 18 and exhaust duct 20. Rotation of power turbine 16 drives output shaft 18, which may be coupled to an electrical generator (not shown) that is also part of power generator 13. Power turbine 16 may, for example, also drive a pump (not shown) or gearbox (not shown). Gas generated by gas generator 12 passes through power turbine 16 and leaves engine 10 via exhaust duct 20.

As is known in the art of gas turbine engines, incoming ambient air becomes pressurized within low and high pressure compressor sections 12A and 12B. Fuel mixes with the pressurized air in combustor section 12C, where it is burned. Once burned, combustion gases expand through high and low pressure turbine sections 12D and 12E and into power turbine 16. From power turbine 16, the combustion gases flow through power turbine exhaust section 14. High and low pressure turbine sections 12D and 12E drive high and low pressure rotor shafts, respectively, within engine 10 that rotate in response to the flow of the combustion gases thereby rotating the attached high and low pressure compressor sections 12B and 12A, respectively.

It is understood that FIG. 1 provides a basic understanding and overview of the various sections and the basic operation of an industrial gas turbine engine and that those skilled in the art will understand the complexities of gas turbine engine operation and the Brayton cycle. Although described with reference to an industrial gas turbine engine having a power turbine, the present application is applicable to all types of gas turbine engines, including those with aerospace or aircraft applications, and more generally to any rotating shaft system having separable component interfaces at one or more locations. Although FIG. 1 is described with reference to high and low pressure spools (“dual spool”), the present disclosure may be used with single spool engines having only a single compressor stage and a single turbine stage. Additionally, while an embodiment of engine 10 has been described having low and high pressure turbine sections with connection to a generator via a power turbine, it will be appreciated that the scope of the disclosure is not so limited, and may apply to other arrangements, such as those connected to a generator via the compressor shaft, for example. A gas turbine system as described herein can include a power turbine, a high pressure turbine, a low pressure turbine, high and low pressure compressors, and any component, system or sub-system of a gas turbine engine, industrial gas turbine or the like including rotating components.

High pressure turbine section 12D comprises first stage vane 22, first stage turbine blade 24 and second stage vane 26. First stage vane 22 and second stage vane 26 are joined to engine case 28 at their radially outer ends. First stage turbine blade 24 is connected to first stage rotor disk 30 at its radially inner end. The present disclosure is directed towards features for balancing the rotation of turbine components, such as blade 24 and rotor disk 30 and the shaft to which they are mounted in high pressure turbine section 12D. The present disclosure is applicable to other components of gas turbine engines, such as other rotating components and the like. For example, gas turbine engine 10 may include additional stages of blades, such those in low pressure turbine section 12E, compressor sections 12A and 12B and power turbine 16, that can incorporate the features of the present disclosure, but are not described for brevity. The teachings of the present disclosure are particularly well suited for balancing components of power turbine 16, where it can sometimes be difficult to access the components of power turbine 16 to conduct field balancing operations. Rotor disk 30 and the high and low pressure rotor shafts that drive high and low pressure turbine sections 12D and 12E, respectively, each comprise a rotating component. Rotor disks can be referred to as “rotors” and rotors shafts can be referred to as “shafts.”

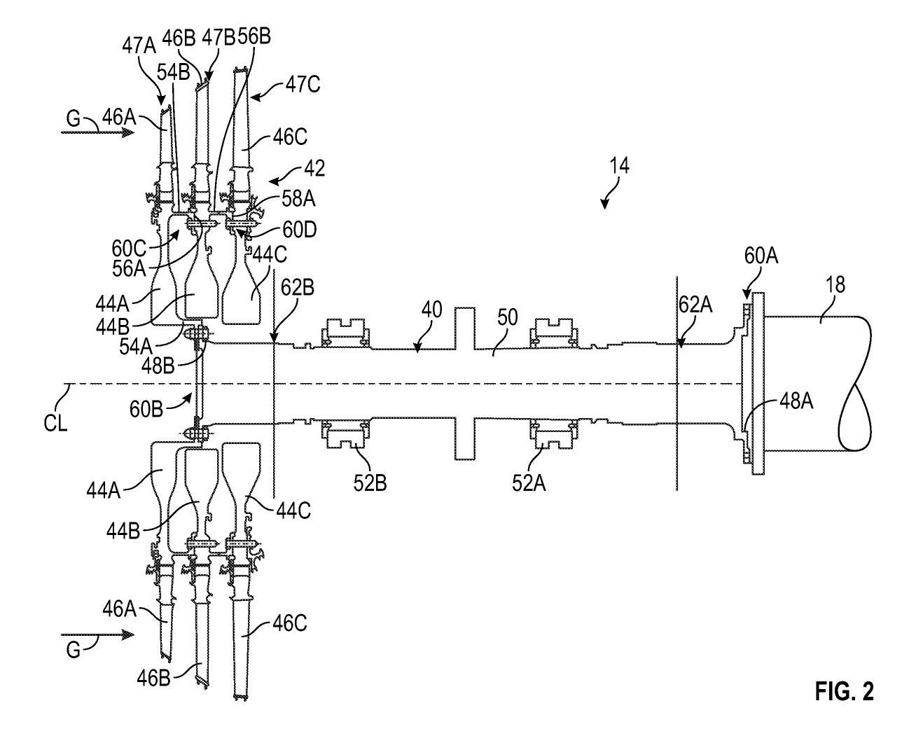

FIG. 2 is a schematic side view of shaft 40 and turbine 42 for use in power turbine 16 of FIG. 1. Turbine 42 can comprise first stage rotor 44A, second stage rotor 44B, third stage rotor 44C, first stage blades 46A, second stage blades 46B and third stage blades 46C. First stage blades 46A, second stage blades 46B and third stage blades 46C can each comprise a plurality of blades distributed around the circumferences of first stage rotor 44A, second stage rotor 44B, third stage rotor 44C, respectively. First stage rotor 44A and first stage blades 46A can be assembled to form first bladed disk 47A. Second stage rotor 44B and second stage blades 46B can be assembled to form second bladed disk 47B. Third stage rotor 44C and third stage blades 46C can be assembled to form third bladed disk 47C. When assembled with necessary seals and fasteners, bladed disks 47A-47C can be characterized as a “rotor stack” and in this particular example a “three-disk rotor stack.” Such assemblies can include knife edge air seals, nuts, bolts and other hardware.

Shaft 40 can include first shaft attachment feature 48A, second shaft attachment feature 48B and barrel 50. Shaft 40 can be mounted for rotation, such as within a power generator or within a balancing machine, using bearings 52A and 52B, which may comprise any bearings suitable for use in a gas turbine engine, such as ball bearings, roller bearings, thrust bearings and the like. Barrel 50 can be configured to extend along centerline CL, while first and second shaft attachment features 48A and 48B can have centers that are eccentric or offset from, or angularly misaligned to, centerline CL.

First stage rotor 44A can include first attachment feature 54A and second attachment feature 54B. Second stage rotor 44B can include first attachment feature 56A and second attachment feature 56B. Third stage rotor 44C can include first attachment feature 58A.

First shaft attachment feature 48A can be used to connect power turbine 16 to a component or system that can utilize a rotational input, such as an electric generator or other mechanical drive, such as a pump, for example. In an example, first shaft attachment feature 48A can be connected to output shaft 18 of FIG. 1 at first interface 60A. Second shaft attachment feature 48B can be used to connect shaft 40 to a rotor stack having a plurality of rotor disks. In an example, second shaft attachment feature 48B can be connected to first stage rotor 44A at second interface 60B. Second shaft attachment feature 48B can also be connected to a rotor disk that is not part of a rotor stack. Shaft attachment features 48A and 48B can comprise any suitable interface as is known in the art. For example, shaft attachment features 48A and 48B can include radial snap fit mechanical joints that are snapped into engagement with another feature and subsequently fastened together, such as by threaded fasteners or bolts. For example, first attachment feature 48A can be coupled to a mating ring of a coupling shaft that extends around the outer circumference of first shaft attachment feature 48A. Second shaft attachment feature 48B can be coupled to a mating ring of first attachment feature 54A that extends around the outer circumference of second attachment feature 48B. Due to the ring or circular shape of attachment features 48A and 48B, attachment features 48A and 48B have a center point that can, due to manufacturing tolerances, be offset from or misaligned to, centerline CL.

Second shaft attachment feature 48B can connect to first attachment feature 54A of first stage rotor 44A at second interface 60B. Second attachment feature 54B of first stage rotor 44A can be connected to first attachment feature 56A of second stage rotor 44B at third interface 60C. Second attachment feature 56B of second stage rotor 44B can be connected to first attachment feature 58A of third stage rotor 44C at fourth interface 60D. Attachment features 54B, 56A, 56B and 58A can comprise any suitable attachment feature as is known in the art, such as splines, fastened flanges, snap rings, lock rings, radial snap fits, and the like. In the illustrated embodiment, attachment feature 54B can comprise a flange extending from rotor 44A, attachment feature 56A can comprise a bore extending through rotor 44B, attachment feature 56B can comprise a flange extending from rotor 44B and attachment feature 58A can comprise a bore extending through rotor 44C. As such, attachment feature 54B and 56A can be coupled via a fastener, such as a bolt. Likewise, attachment feature 56B and 58A can be coupled via a fastener, such as a bolt.

Attachment features 54A and 54B of first stage rotor 44A can be eccentric to or offset from, or angularly misaligned to, the mass center of the disk comprising first stage rotor 44A. Attachment features 56A and 56B of second stage rotor 44B can be eccentric to or offset from, or angularly misaligned to, the mass center of the disk comprising second stage rotor 44B. Attachment features 58A of third stage rotor 44C can be eccentric to or offset from, or angularly misaligned to, the mass center of the disk comprising third stage rotor 44C.

When shaft 40 and turbine 42 are installed in gas turbine engine 10, such as within power turbine 16, high energy gas produced by combustor section 12C (FIG. 1) flows along a gas path (designated generally as G) in an axial direction, which extends sequentially past blades 46A, 46B and 46C, thereby causing rotation of shaft 40 on bearings 52A and 52B via connection to rotors 44A-44C. Blades 46A, 46B and 46C and rotors 44A, 44B and 44C rotate at high speeds, and are therefore subject to various forces. As such, any asymmetry in the load distribution in any of the rotating components can cause unbalance in the system and vibration during operation. It can, therefore, be desirable to balance each of the rotating components. Ideally, each component is balanced individually such that when assembled to each other in a system, the system is also balanced. However, with current manufacturing practices, it is generally not possible to manufacture each component so as to be assembled into a perfectly balanced system. For example, shaft 40 can typically not be manufactured such that centerline CL of barrel 50 is co-axial or coincident, or angularly aligned with the centerlines of shaft attachment features 48A and 48B.

In order to balance a turbine according to conventional practice, a shaft is balanced based on the mass and the geometric center of the shaft. Unbalance correction weight is added to or subtracted from material of the as-manufactured shaft in order to reduce variations that may give rise to vibration during operation. A balancing machine can be used to determine unbalance in the shaft at two locations (e.g., first and second reference locations 62A and 62B) in a “dual plane” technique. Generally, balancing machines are configured for balancing a single component at a time. For example, the weight capacity of typical balancing machines may be limited to a weight below the total weight of a shaft, rotor stack and blade assembly. Unbalance correction weight can be removed from the shaft in any suitable manner, such as by grinding, or can be added to the shaft by the addition of weights. Separately, a 3-disk rotor stack can be balanced as an assembly on a conventional balancing machine and attached to the shaft at second interface 60B. In an example, the assembled shaft and rotor stack are then installed into a housing for a power turbine.

With the assembled shaft and rotor stack installed into a power turbine in the field, the gas generator is operated to rotate the power turbine, and vibration measurements are observed and recorded, using various sensors mounted to the power turbine, such as at the housings of the shaft bearings, such as bearings 52A and 52B. If the vibration measurements exceed desired magnitudes, such as of an acceptable tolerance band, a trim balance can be performed.

As mentioned, because it can be difficult to access and assemble or disassemble components of power turbine 16 in the field, trim balancing corrections can typically only be made at somewhat ineffective locations proximate to first interface 60A (i.e. near the electric generator). For example, the size and weight of housing components for power turbine 16 are difficult to move and turbine 42 is difficult to access within the housing components. Furthermore, power turbines can employ an overhung design where the coupling locations (e.g., interfaces 60C and 60D) between rotor disks is cantilevered back over the shaft from the first stage rotor disk, further hindering the accessibility of coupling locations between the second and third stage rotor disks.

In the balancing operation of the present disclosure, mass property (such as weight and diametral moment of inertia) scaled devices, or simulators, are created, fabricated, produced or manufactured that can be attached to shaft 40 to simulate connection to other components, such as assemblies of blades 46A, 46B and 46C and rotors 44A, 44B and 44C. The mass property scaled device will be independently balanced. The shaft 40 and the mass property scaled devices can be assembled and rotated together in a balancing machine, without the size and weight of balancing the actual shaft 40-turbine 42 assembly in the balancing machine, or the assembly and accessibility constraints of balancing the actual shaft 40-turbine 42 assembly in the field. As such, the need for performing field balancing operations can be reduced or eliminated. The mass property scaled devices can identify and account for mounting eccentricities and angular misalignments between components that can arise in coupling and attachment interfaces between components. Mass property scaled devices can also be used to balance individual rotor disks in a rotor disk stack.

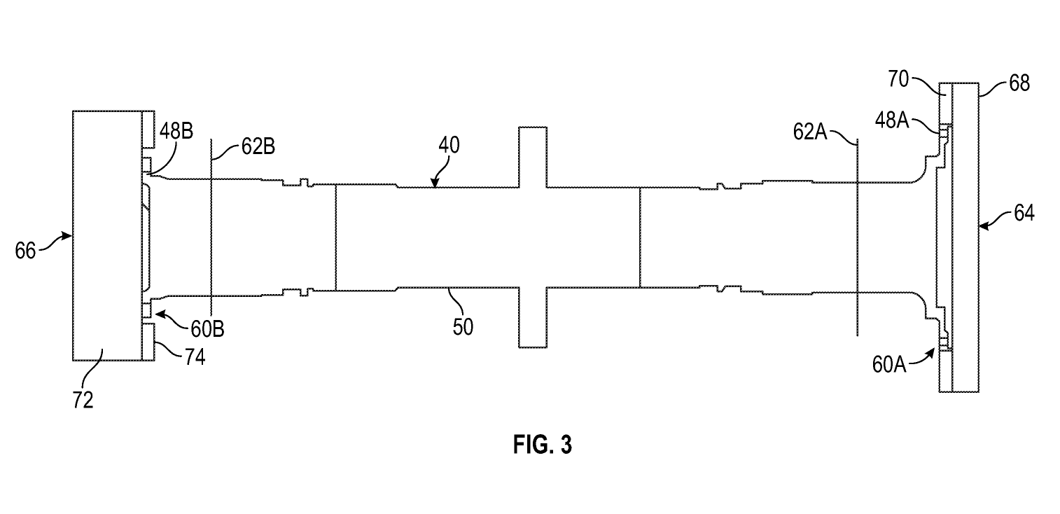

FIG. 3 is a schematic cross-sectional view of shaft 40 of FIG. 2 coupled to first simulator 64 at a first end and second simulator 66 at a second end. First simulator 64 can be configured to simulate mass properties of a coupling shaft, such as shaft 18 (in FIG. 2), and second simulator 66 can be configured to simulate mass properties of a turbine, such as three-disk rotor stack turbine 42 of FIG. 2. First simulator 64 can be configured to mount to first shaft attachment feature 48A, and second simulator 66 can be configured to mount to second shaft attachment feature 48B.

First simulator 64 and second simulator 66 are designed and fabricated to have rotational dynamic properties identical to, or very nearly identical to, e.g., within 1%, of actual rotational dynamic properties of turbine components that shaft 40 can be mounted to at first and second shaft attachment features 48A and 48B, but that are scaled down in size and weight so as to be more easily handled and manipulated by test equipment, such as a balancing machine.

First simulator 64 can have a center of gravity that mimics, replicates, or is equal to the center of gravity of some portion or all of shaft 18. However, the mass of first simulator 64 can be scaled, such as reduced or scaled down, from the effective mass of shaft 18. (It will be appreciated that the effective mass of shaft 18 is the portion of mass supported by the shaft 40 at first interface 60A, as determined by static analysis.) Likewise, the diametral moment of inertia of first simulator 64 can be reduced or scaled down from the effective diametral moment of inertia of shaft 18. The assembly of the shaft 40 and scaled-down first simulator 64 is thus readily useable with a typical balancing machine. In particular, the combined size and weight of shaft 40 and first simulator 64 is conducive for use in a typical balancing machine and is more readily moveable and workable than the combination of shaft 40 and shaft 18. While embodiments of the simulators described herein have been described as having the same center of gravity as the simulated component, it will be appreciated that the scope of the disclosure is not so limited, and can include simulators having a center of gravity that differs from the simulated component. In such cases, the difference shall be taken into account as part of the balancing process. Further, while an embodiment of a simulator 64 has been described having a scaled down mass, it will be appreciated that the scope of the disclosure is not so limited, and can include simulators that have a mass that has been scaled up from the component being simulated. This may be applicable to identify unbalance sensitivity, such as in situations in which the speed of operation of the simulated component is much greater than the balancing equipment capability.

Second simulator 66 can have a center of gravity that mimics, replicates, or is equal to the center of gravity of three-disk rotor stack turbine 42. However, the mass of second simulator 66 can be scaled, such as reduced or scaled down, from the actual mass of three-disk rotor stack turbine 42. Likewise, the diametral moment of inertia of second simulator 66 can be reduced or scaled down from the actual diametral moment of inertia of three-disk rotor stack turbine 42. The assembly of the shaft 40 and scaled-down second simulator 66 is thus readily useable with a typical balancing machine. In particular, the combined size and weight of shaft 40 and second simulator 66 is conducive for use in a typical balancing machine and is more readily moveable and workable than the combination of shaft 40 and turbine 42.

As an example, a typical power turbine rotor can weigh up to 10,000 lbs (˜4,535.9 kilograms) and a typical power turbine shaft can weigh up to 3,000 lbs (˜1,360.8 kilograms), which can be difficult to manipulate and install into a balancing machine. First simulator 64 can be scaled down to about 150 lbs (˜68.0 kilograms) and second simulator 66 can be scaled down to about 1,000 lbs (˜453.6 kilograms), which is much more readily manipulated and installed into a balancing machine. First and second simulator 64 and 66 can have any size and shape so long as the proper rotational dynamic properties (e.g., same center of gravity, scaled diametral moment of inertia, etc.) discussed above are achieved. First and second simulators 64 and 66 can have the same attachment interfaces as shaft 18 and first stage rotor 44A, or can have a different attachment interface. For example, first simulator 64 can comprise cylindrical body 68 and ring 70. Ring 70 can be fastened to cylindrical body 68 such as via threaded fasteners, or integrally machined into body 68. Ring 70 can be configured to provide a snap interface with shaft attachment feature 48A. Subsequently, fasteners can be used to secure first simulator 64 to shaft attachment feature 48A. Likewise, second simulator 66 can comprise cylindrical body 72 and ring 74. Ring 74 can be fastened to cylindrical body 72 such as via threaded fasteners, or integrally machined into body 72. Ring 74 can be configured to provide a snap interface with shaft attachment feature 48B. Subsequently, fasteners can be used to secure second simulator 66 to shaft attachment feature 48B.

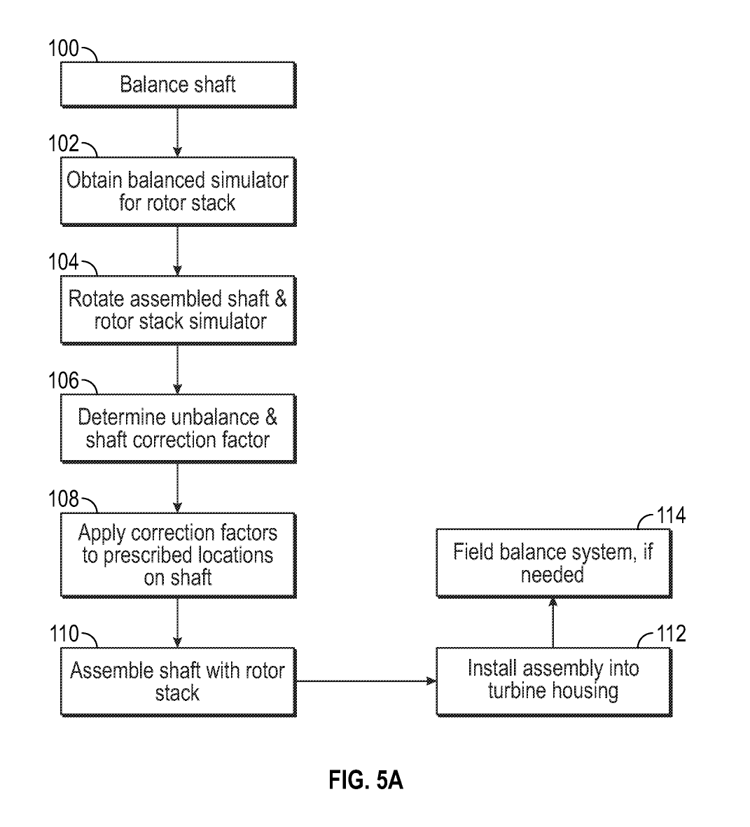

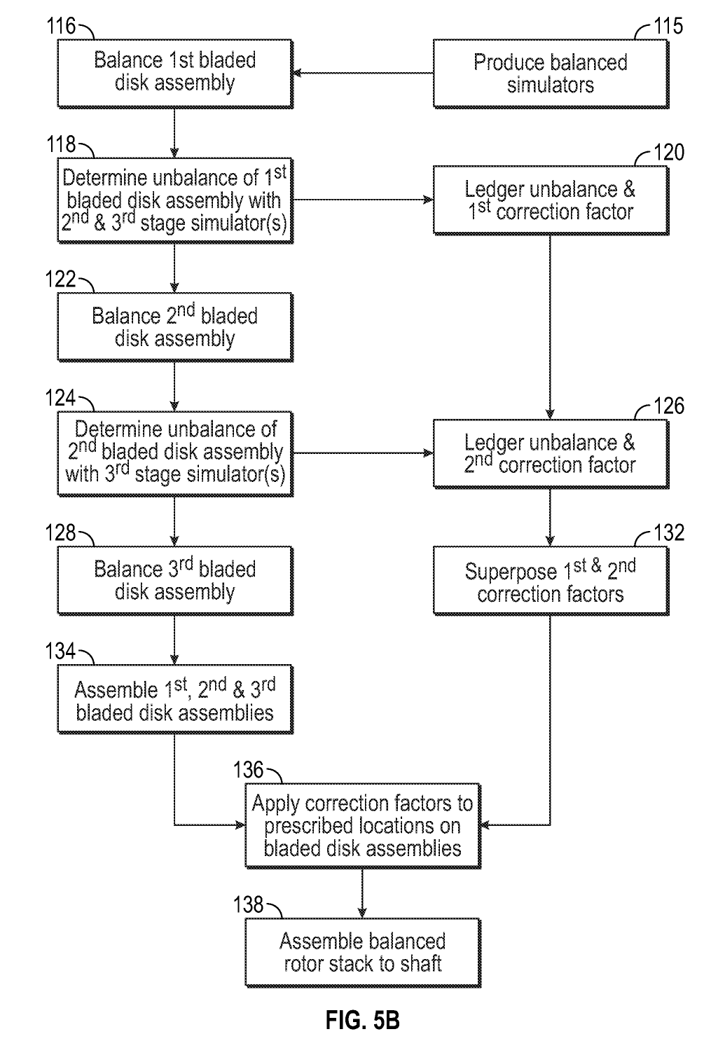

With reference to FIG. 5A and FIG. 3, first, at step 100, shaft 40 can be balanced apart from simulators 64 and 66 and mass can be added or removed at prescribed locations, such as near reference locations 62A and 62B. For example, mass can be added by attaching weights to shaft 40 and mass can be removed by grinding material of shaft 40 away. Next, at step 102, simulators 64 and 66 can be created, produced, fabricated or manufactured and balanced. First simulator 64 can be attached to shaft attachment feature 48A. Thereafter, shaft 40 and first simulator 64 can be rotated in a balancing machine at step 104. Unbalance of shaft 40 and first simulator 64 are observed, monitored, measured and recorded. The balancing machine can be used to determine a “simulator correction factor” for correcting the actual vibration of shaft 40 and first simulator 64. The simulator correction factor will be based upon the actual weight of simulator 64. A “scaling factor” is then applied to the “simulator correction factor” to take into account the scaling down of first simulator 64 to determine the “actual correction factor” for shaft 40 and shaft 18. (It should be understood that if shaft 40 were to be measured in the balancing machine with the “actual correction factor” applied and simulator 64 attached, imbalance would still be detected.) For example, the simulator scaling factor will scale-up the simulator correction factor proportionally to how much the simulator scaled-down the mass of the simulated component.

Thus, simulator 64 is configured to be truly balanced (as shaft 18 will be assumed to have been truly balanced during its manufacture and/or subsequent balancing operation) and the assembly of shaft 40 and first simulator 64, can be balanced by adding or removing weight from shaft 40, such as reference locations 62A and 62B, for example.

This process can be repeated with second simulator 66 (with or without attachment of first simulator 64 to shaft 40). In particular, shaft 40 and second simulator 66 can be rotated at step 104. At step 106, the unbalance of shaft 40 and second simulator 66 in response to the rotation, and an appropriate scaled correction factor, can be determined. At step 108, the balance correction relating to the actual correction factor (e.g. adding or removing mass from shaft 40) can be applied at reference location 62A and 62B.

Thus, by using simulators 64 and 66, shaft 40 can be balanced for coupling to balanced shaft 18 and balanced turbine 42 in order to accommodate imbalance between the centers of attachment features 48A and 48B and centerline CL of barrel 50. This can be done without having to attach the large and heavy components of shaft 18 and turbine 42 to shaft 40 in a balancing machine. Exemplary unbalance correction can be applied to shaft 40 at reference locations 62A and 62B.

Due to accessibility constraints, trim balancing shaft 40 at first interface 60A in the field to account for imbalance in turbine 42 separates the imbalance from the correction and, under some circumstances, makes trim balance of the power turbine rotor system ineffective. With the teachings of the present application, this situation can be mitigated.

At step 110, after shaft 40 is balanced using simulators 64 and 66, shaft 40 can be attached to turbine 42 and, at step 112, attached to shaft 18 and installed into gas turbine engine 10 (FIG. 1). At step 114, in the field, at the location of gas turbine engine 10, power turbine 16 can be rotated, such as by operating gas generator 12 (FIG. 1). Vibrations of power turbine 16 can be observed, measured and recorded, such as at the locations of bearings 52A and 52B. The vibrations of power turbine 16 are expected to be below an actionable threshold, above which trim balancing is typically employed. However, if unbalance is present, field balancing power turbine 16, such via trim balancing, can be conducted in a conventional manner.

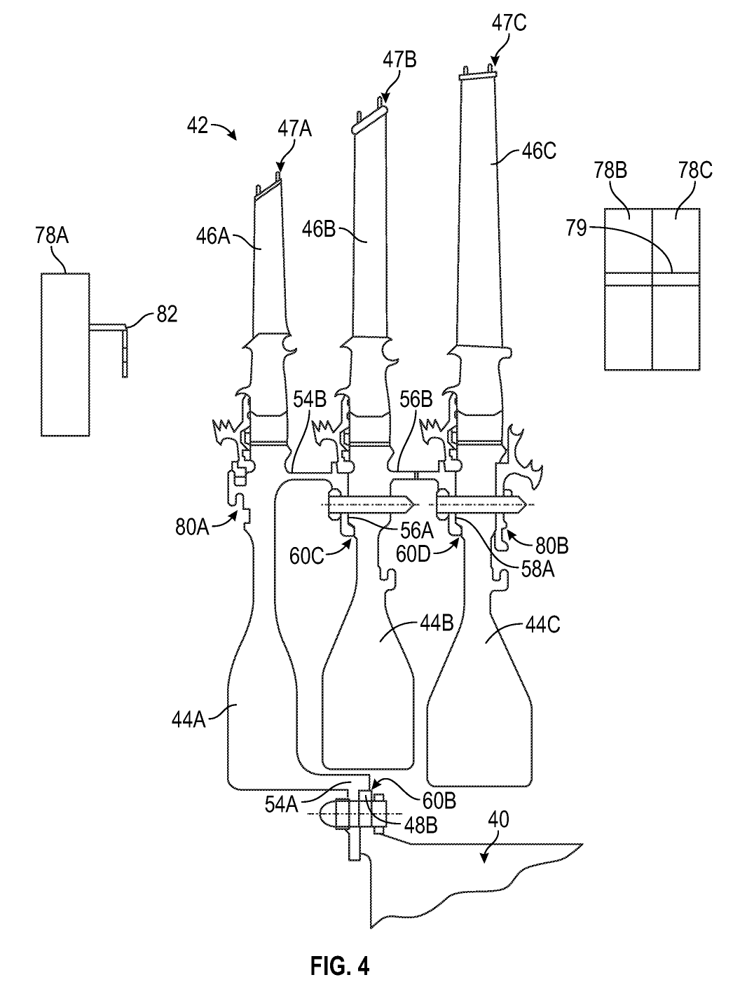

FIG. 4 is a schematic view of the three-disk rotor stack turbine 42 of FIG. 2 showing the location for simulators for sequential balancing of each rotor disk 44A, 44B and 44C. First stage rotor 44A can include first attachment feature 54A that can connect to first shaft attachment feature 48B at second interface 60B. First stage rotor 44A can also include second attachment feature 54B that can connect to first attachment feature 56A of second stage rotor 44B at third interface 60C. Second stage rotor 44B can include second attachment feature 56B that can connect to first attachment feature 58A of third stage rotor 44C at fourth interface 60D.

Three-disk rotor stack 42 includes interfaces 60B, 60C and 60D, which can comprise locations where components are joined together. For example, interface 60B can include first attachment feature 54A from first stage rotor 44A, as well as shaft attachment feature 48B from shaft 40; interface 60C can include second attachment feature 54B from first stage rotor 44A and first attachment feature 56A from second stage rotor 44B; and interface 60D can include second attachment feature 56B from second stage rotor 44B and first attachment feature 58A from third stage rotor 44C.

First stage rotor 44A can be part of two interfaces 60B and 60C for connecting to shaft 40 and second stage rotor 44B, respectively. Second stage rotor 44B is also connected to third stage rotor 44C. Similar to the eccentricities and angular misalignment that can exist between second shaft attachment feature 48B and shaft 40 centerline CL, there can be manufacturing-related eccentricity and angular misalignment between attachment features 54A and 54B of second interface 60B and third interface 60C, respectively. Second stage rotor 44B can be part of two interfaces 60C and 60D for connecting to first stage rotor 44A and third stage rotor 44C. Similar to the eccentricities that can exist elsewhere in the system, there can be manufacturing-related eccentricity between attachment features 56A and 56B of third interface 60C and fourth interface 60D. Third stage rotor 44C can be part of one interface 60D for connecting to second stage rotor 44B.

Use of a simulator provides for a more efficient rotor balancing process by eliminating the need to balance the full assembly of turbine 42. Simulators can be provided, produced or manufactured that simulate the rotational dynamic properties of each rotor 44A-44C, or various combinations of rotors 44A-44C.

First simulator 78A can be made to simulate first stage rotor 44A. Second simulator 78B can be made to simulate second stage rotor 44B. Third simulator 78C can be made to simulate third stage rotor 44C. Additionally, a fourth simulator could be made to simulate second and third stage rotors 44B and 44C, or second and third simulators 78B and 78C can be made to be combined, e.g., attach to each other. In another example, simulators 78A, 78B and 78C can be configured to be combined, e.g. attach to each other to form simulator 66 (FIG. 3). Simulators 78A-78C can include various attachment features to connect to each other and to connect to rotors 44A-44C. For example, first simulator 78A can include flange 82 for connecting to a through-bore on a rotor, such as at attachment feature 56A or 58A. Second simulator 78B and third simulator 78C can be configured to connect to each other, such as with a snap ring connection, and can include through-bore 79 for coupling to attachment features 54B and 56B or rotors 44A and 44B, for example. Simulators 78A-78C may include any other appropriate attachment features, such as snap-fit recesses or protrusions, rings, bores, or the like.

Each simulator can be balanced with respect to its respective attachment feature, and can have a center of gravity that mimics, replicates or is equal to the center of gravity of the associated rotor being simulated. However, the mass of each simulator can be reduced or scaled-down from the actual mass of its associated rotor. Likewise, the diametral moment of inertia of each simulator can be reduced or scaled-down from the actual diametral moment of its associated rotor.

The rotor stack comprising turbine 42 can be balanced by successively balancing each rotor 44A-44C with a simulator representing the components “downstream” from shaft 40. That is, for example, second simulator 78B and third simulator 78C (or a single simulator representing both) can be connected to first stage rotor 44A at second attachment feature 54B in order to balance first stage rotor 44A; third simulator 78C can be connected to second stage rotor 44B at second attachment feature 56B in order to balance second stage rotor 44B. A simulator is not necessary to connect to third stage rotor 44C because third stage rotor 44C has no downstream component. As such, the rotor stack comprising turbine 42 can be balanced for attachment to shaft 40, such as in the manner discussed above. Downstream can connote the direction of sequential mechanical coupling between successive rotors, with upstream connoting the opposite direction.

With reference to FIG. 5B and FIG. 4, simulators 78A, 78B and 78C facilitate a balance process starting with balancing of first stage rotor 44A and first stage blades 46A. At step 115, the appropriate simulators 78A-78C are each produced and balanced with respect to their attachment feature or features. At step 116, first bladed disk 47A can be balanced apart from bladed disks 47B and 47C and simulators 78A-78C. Subsequently, or separately, first bladed disk 47A can be balanced with respect to third interface 60C with simulators 78B and 78C representing the second bladed disk 47B and third bladed disk 47C, respectively. As above, simulators 78B and 78C can have a scaled mass and diametral moment of inertia, but with the same center of gravity as the assembled second stage bladed disk 47B and third stage bladed disk 47C. Simulators 78B and 78C can allow for the determination and correction of any run out or angular misalignment between second interface 60B and third interface 60C, such as between attachment features 54A and 54B. In the illustrated embodiment, simulators 78B and 78C can be coupled to each other and can include through-bore 79 to couple to attachment feature 54B of first stage rotor 44A.

It will be noted that first stage rotor 44A, in and of itself, may not include enough width to provide for an appropriate bi-plane balance weight addition or removal. Therefore, two bi-plane points of the three-disk rotor stack of turbine 42 can be selected, with a first bi-planar point 80A selected on an upstream side first stage rotor 44A, and second bi-planar point 80B selected on a downstream side of third stage rotor 44C.

At step 118, an assembly of first bladed disk 47A and simulators 78B and 78C can be rotated, such as in a balancing machine to determine the unbalance of the assembly. At step 120, unbalance of first bladed disk 47A and simulators 78B and 78C can be recorded or entered into a ledger, and based upon the scaling factors, the appropriate correction factors, (e.g., the amount of balance mass addition and/or removal of weight at locations 80A and 80B), can be calculated and book-kept as the polar coordinates (R, θ) at the bi-planar locations 80A and 80B.

At step 122 second bladed disk 47B can be balanced apart from bladed disks 47A and 47C and simulators 78A-78C. At step 124, subsequently, an assembly of second bladed disk 47B can be rotated, such as in a balancing machine, with simulator 78C representing third bladed disk 47C to determine the unbalance of the assembly. As discussed above, simulator 78C can have a scaled mass and diametral moment of inertia, but with the same center of gravity as third bladed disk 47C. Simulator 78C can allow for the determination and correction of any run out between third interface 60C and fourth interface 60D, such as between attachment features 56A and 56B. In the illustrated embodiment, simulator 78C can be separated from simulator 78B, and can be coupled to attachment featured 56B of second stage rotor 44B at through-bore 79.

It will be noted that second stage rotor 44B, in and of itself, may not include enough width to provide for an appropriate bi-plane balance weight addition or removal. Therefore, two bi-plane points of the three-disk rotor stack of turbine 42 can be selected, with a first bi-planar point 80A selected on an upstream side of first stage rotor 44A, and second bi-planar point 80B selected on a downstream side of third stage rotor 44C.

At step 126, unbalance of second bladed disk 47BA and simulator 78C can be recorded or entered into a ledger, and based upon the scaling factors, the appropriate correction factors, (e.g., the amount of balance mass addition and/or removal of weight at locations 80A and 80B), can be calculated and book-kept as the polar coordinates (R, θ) at the bi-planar locations 80A and 80B.

At step 128, third bladed disk 47C can be balanced apart from bladed disks 47A and 47B and simulators 78A-78C. Third bladed disk 47C can be balanced with respect to attachment feature 58A, and a simulator is not needed, since (in this example) there is no additional attachment interface “downstream” from third bladed disk 47C to introduce any further imbalance.

It will be noted that third stage rotor 44C, in and of itself, may not include enough width to provide for an appropriate bi-plane balance weight addition or removal. Therefore, two bi-plane points of the three-disk rotor stack of turbine 42 can be selected, with first bi-planar point 80A selected on an upstream side of first stage rotor 44A, and second bi-planar point 80B selected on a downstream side of third stage rotor 44C.

As an optional step, third stage rotor 44C can be rotated, such as in a balancing machine, to determine he unbalance of third stage rotor 44C. Appropriate correction factors can be applied to third stage rotor 44C or the assembly, or unbalance can be recorded or entered into a ledger, and appropriate correction factors, (e.g., the amount of balance mass addition and/or removal of weight at locations 80A and 80B), can be calculated and book-kept as the polar coordinates (R, θ) at the bi-planar locations 80A and 80B.

At step 132, the book-keeping of the correction factors for each of the steps above can be superposed to determine the appropriate modifications (addition or removal of weight at locations 80A and 80B) to be made to first stage rotor 44A and third stage rotor 44C.

At step 134, rotors 44A-44C can be assembled. It is not necessary to balance the three-disk rotor stack comprising turbine 42, since eccentricity of the attachment interfaces (unbalance contributors) have been identified and corrected at the component level.

At step 136, the correction factors determined from superposition at step 132 can be applied to first stage rotor 44A and third stage rotor 44C at locations 80A and 80B. At step 138, the assembly of rotors 44A-44C can be connected to shaft 40 and installed in power turbine 16.

This allows for providing a balanced rotor assembly of turbine 42 without the need to actually balance the assembled three-disk rotor stack of turbine 42. This reduces the necessary balancing equipment capacity requirements, and therefore capital cost(s) and/or increases the number of potential capable balance vendors. It also reduces any risks and difficulties of field trim balancing.

While aspects of the disclosure have been described as turbine blade embodiments, it will be appreciated that the scope of the disclosure is not so limited, and may apply to other devices consisting of built-up assemblies that include large amounts of mass subject to rotation.

### VARIOUS NOTES & EXAMPLES

Example 1 can include or use subject matter such as a method of balancing a mounting eccentricity or misalignment between first and second rotating components of a gas turbine system, the method can comprise: balancing a first rotating component apart from the second rotating component, the first rotating component can comprise: a first body extending along a central axis, and a first attachment interface positioned at a first end of the body, the first attachment interface having a first center offset from the central axis; attaching a first simulator to the first attachment feature, the first simulator can have: rotational dynamic properties located around a center point that are equivalent to rotational dynamic properties of the second rotating component, and a simulator mass properties scaled-down from mass properties of the second rotating component; rotating the first rotating component and the first simulator together; determining a first simulator correction factor to apply to the gas turbine system to balance the first rotating component and the first simulator; and scaling-up the first simulator correction factor to determine a first actual correction factor to apply to the gas turbine system to balance the first rotating component and the second rotating component.

Example 2 can include, or can optionally be combined with the subject matter of Example 1, to optionally include applying the first actual correction factor to the gas turbine system.

Example 3 can include, or can optionally be combined with the subject matter of one or any combination of Examples 1 or 2 to optionally include applying the first actual correction factor to the first rotating component.

Example 4 can include, or can optionally be combined with the subject matter of one or any combination of Examples 1 through 3 to optionally include applying the first actual correction factor comprises adding or removing weight from the first rotating component.

Example 5 can include, or can optionally be combined with the subject matter of one or any combination of Examples 1 through 4 to optionally include removing the first simulator from the first attachment feature of the first rotating component; and attaching the second rotating component to the first attachment feature.

Example 6 can include, or can optionally be combined with the subject matter of one or any combination of Examples 1 through 5 to optionally include rotating the first and second rotating components as an assembly; monitoring vibration of the assembly; and evaluating a need for trim balancing the assembly.

Example 7 can include, or can optionally be combined with the subject matter of one or any combination of Examples 1 through 5 to optionally include the first center and the center point being concentric.

Example 8 can include, or can optionally be combined with the subject matter of one or any combination of Examples 1 through 7 to optionally include rotational dynamic properties comprising a center of gravity, and a simulator having a scaled diametral moment of inertia of the second rotor component.

Example 9 can include, or can optionally be combined with the subject matter of one or any combination of Examples 1 through 8 to optionally include first and second rotating components that are components for a power turbine of an industrial gas turbine.

Example 10 can include, or can optionally be combined with the subject matter of one or any combination of Examples 1 through 9 to optionally include a first rotating component comprising a shaft for a turbine and a second rotating component comprising a disk for the turbine.

Example 11 can include, or can optionally be combined with the subject matter of one or any combination of Examples 1 through 10 to optionally include a first rotating component comprising a first disk for a turbine and a second rotating component comprising a second disk for the turbine.

Example 12 can include, or can optionally be combined with the subject matter of one or any combination of Examples 1 through 11 to optionally include: balancing the second rotating component apart from the first rotor component; attaching a second simulator to the second rotating component, the second simulator having: rotational dynamic properties that are equivalent to rotational dynamic properties of a third rotating component, and a simulator mass scaled-down from a mass of the third rotor component; rotating the second rotating component and the second simulator together; determining a second simulator correction factor to apply to the gas turbine system to balance the second rotating component and the second simulator; and scaling-up the second simulator correction factor to determine a second actual correction factor to apply to the gas turbine system to balance the second rotating component and the third rotating component.

Example 13 can include, or can optionally be combined with the subject matter of one or any combination of Examples 1 through 12 to optionally include balancing the third rotating component apart from the first and second rotating components to determine a third actual correction factor; adding the first, second and third actual correction factors to determine a summed correction factor; and applying the summed correction factor to the first and third rotor components.

Example 14 can include or use subject matter such as a method of balancing a rotor assembly for use with a gas turbine engine system, the method comprising: attaching a simulator to a shaft of the rotor assembly, the simulator having a scaled mass property and a scaled geometry of a rotor disk of the rotor assembly, and wherein a center of gravity of the simulator is equal to a center of gravity of the rotor disk; determining unbalance of the shaft and simulator when rotating together as an assembly apart from the rotor disk; and calculating an un-scaled magnitude of a weight correction and a location for the weight correction on the shaft to offset vibration of the rotor disk when the weight correction is applied to the shaft.

Example 15 can include, or can optionally be combined with the subject matter of Example 14, to optionally include a applying the weight correction to the shaft at the location and attaching the rotor disk to the shaft.

Example 16 can include, or can optionally be combined with the subject matter of one or any combination of Examples 14 or 15 to optionally include attaching the rotor disk and shaft to the gas turbine engine system.

Example 17 can include, or can optionally be combined with the subject matter of one or any combination of Examples 14 through 16 to optionally include a gas turbine engine system comprising a power turbine for an industrial gas turbine engine.

Example 18 can include, or can optionally be combined with the subject matter of one or any combination of Examples 14 through 17 to optionally include monitoring vibration of the rotor disk and shaft in the gas turbine engine system; and if necessary, trim balancing the rotor disk and shaft.

Example 19 can include, or can optionally be combined with the subject matter of one or any combination of Examples 14 through 18 to optionally include a simulator having a scaled-down mass property and a scaled-down geometry of a rotor disk and a plurality of blades mounted to the rotor disk, and wherein a center of gravity of the simulator is equal to a center of gravity of the rotor disk and the plurality of blades.

Example 20 can include, or can optionally be combined with the subject matter of one or any combination of Examples 14 through 19 to optionally include balancing the shaft apart from the rotor disk before attaching the simulator to the shaft.

Example 21 can include or use subject matter such as a method of balancing a gas turbine rotor disk stack having rotor disks successively arranged from a first end for connecting to a shaft to a second end in a sequential direction from the first end; the method comprising: individually balancing each rotor disk of the rotor disk stack; individually rotating selective rotor disks with respective simulators, the respective simulators corresponding to any subsequent sequential rotor disks connected to the selective rotor disks in the sequential direction, each simulator comprising: a scaled mass and a scaled geometry of the subsequent sequential rotor disks; and a center of gravity that is equal to a center of gravity of the subsequent sequential rotor disks; individually determining unbalance of each selective rotor disk and each respective simulator; calculating an un-scaled magnitude of a weight correction and a location for the weight correction on end disks of the rotor disk stack to offset vibration of each selective rotor disk when the weight correction is applied to the rotor disk stack; and aggregating the weight corrections for each of the selective rotor disks for applying the weight corrections to the end disks in the rotor disk stack.

Example 22 can include, or can optionally be combined with the subject matter of Example 21, to optionally include attaching the rotor disk stack to the shaft at the first end; installing the rotor disk stack and the shaft into bearings within a housing; monitoring vibration of the rotor disk stack and shaft in the gas turbine engine system; and evaluating a need for trim balancing of the rotor disk stack and shaft.

Example 23 can include, or can optionally be combined with the subject matter of one or any combination of Examples 21 or 22 to optionally include each rotor disk including a plurality of blades distributed around a circumference of each rotor disk.

Example 24 can include, or can optionally be combined with the subject matter of one or any combination of Examples 21 through 23 to optionally include each simulator having a diametral moment of polar inertia that is scaled-down from a diametral moment of polar inertia of the sequential rotor disks.

Example 25 can include, or can optionally be combined with the subject matter of one or any combination of Examples 21 through 24 to optionally include a rotor disk stack including: a first rotor disk having a first attachment feature for connecting to the shaft; a second rotor disk having a second attachment feature for connecting to the first rotor disk; a third rotor disk having a third attachment feature for connecting to the second rotor disk; and the method further comprising: balancing the first rotor disk with a first simulator corresponding to the second rotor disk and the third rotor disk; and balancing the second rotor disk with a second simulator corresponding to the third rotor disk.

Example 26 can include, or can optionally be combined with the subject matter of one or any combination of Examples 21 through 25 to optionally include balancing the respective simulators before rotating with a selective rotor disk.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A method of balancing a mounting eccentricity or misalignment between first and second rotating components of a gas turbine system, the method comprising:
balancing a first rotating component apart from the second rotating component, the first rotating component comprising:
a first body extending along a central axis; and
a first attachment interface positioned at a first end of the body, the first attachment interface having a first center offset from the central axis;
attaching a first simulator to the first attachment feature, the first simulator having:
rotational dynamic properties located around a center point that are equivalent to rotational dynamic properties of the second rotating component; and
simulator mass properties scaled-down from a mass of the second rotating component;
rotating the first rotating component and the first simulator together;
determining a first simulator correction factor to apply to the gas turbine system to balance the first rotating component and the first simulator; and
scaling-up the first simulator correction factor to determine a first actual correction factor to apply to the gas turbine system to balance the first rotating component and the second rotating component.

2. The method of claim 1, further comprising applying the first actual correction factor to the gas turbine system.

3. The method of claim 2, further comprising applying the first actual correction factor to the first rotating component.

4. The method of claim 3, wherein applying the first actual correction factor comprises adding or removing weight from the first rotating component.

5. The method of claim 3, further comprising:
removing the first simulator from the first attachment feature of the first rotating component; and
attaching the second rotating component to the first attachment feature.

6. The method of claim 5, further comprising:
rotating the first and second rotating components as an assembly;
monitoring vibration of the assembly; and
evaluating a need for trim balancing the assembly.

7. The method of claim 1, wherein the first center and the center point are concentric.

8. The method of claim 1, wherein the rotational dynamic properties comprise a center of gravity, and the simulator has a scaled diametral moment of inertia of the second rotor component.

9. The method of claim 1, wherein the first and second rotating components are components for a power turbine of an industrial gas turbine.

10. The method of claim 1, wherein the first rotating component comprises a shaft for a turbine and the second rotating component comprises a disk for the turbine.

11. The method of claim 1, wherein the first rotating component comprises a first disk for a turbine and the second rotating component comprises a second disk for the turbine.

12. The method of claim 11, further comprising:
balancing the second rotating component apart from the first rotor component;
attaching a second simulator to the second rotating component, the second simulator having:
rotational dynamic properties that are equivalent to rotational dynamic properties of a third rotating component; and
simulator mass properties scaled-down from a mass of the rotor component;
rotating the second rotating component and the second simulator together;
determining a second simulator correction factor to apply to the gas turbine system to balance the second rotating component and the second simulator; and
scaling-up the second simulator correction factor to determine a second actual correction factor to apply to the gas turbine system to balance the second rotating component and the third rotating component.

13. The method of claim 12, further comprising:
balancing the third rotating component apart from the first and second rotating components to determine a third actual correction factor;
adding the first, second and third actual correction factors to determine a summed correction factor; and
applying the summed correction factor to the first and third rotor components.

14. A method of balancing a rotor assembly for use with a gas turbine engine system, the method comprising:
attaching a simulator to a shaft of the rotor assembly, the simulator having a scaled mass property and a scaled geometry of a rotor disk of the rotor assembly, and wherein a center of gravity of the simulator is equal to a center of gravity of the rotor disk;
determining unbalance of the shaft and simulator when rotating together as an assembly apart from the rotor disk; and
calculating an un-scaled magnitude of a weight correction and a location for the weight correction on the shaft to offset vibration of the rotor disk when the weight correction is applied to the shaft.

15. The method of claim 14, further comprising applying the weight correction to the shaft at the location and attaching the rotor disk to the shaft.

16. The method of claim 15, further comprising attaching the rotor disk and shaft to the gas turbine engine system.

17. The method of claim 16, wherein the gas turbine engine system comprises a power turbine for an industrial gas turbine engine.

18. The method of claim 16, further comprising:
monitoring vibration of the rotor disk and shaft in the gas turbine engine system; and
if necessary, trim balancing the rotor disk and shaft.

19. The method of claim 14, wherein the simulator has a scaled-down mass property and a scaled-down geometry of a rotor disk and a plurality of blades mounted to the rotor disk, and wherein a center of gravity of the simulator is equal to a center of gravity of the rotor disk and the plurality of blades.

20. The method of claim 14, further comprising balancing the shaft apart from the rotor disk before attaching the simulator to the shaft.

21. A method of balancing a gas turbine rotor disk stack having rotor disks successively arranged from a first end for connecting to a shaft to a second end in a sequential direction from the first end, the method comprising:
individually balancing each rotor disk of the rotor disk stack;
individually rotating selective rotor disks with respective simulators, the respective simulators corresponding to any subsequent sequential rotor disks connected to the selective rotor disks in the sequential direction, each simulator comprising:
a scaled mass and a scaled geometry of the subsequent sequential rotor disks; and
a center of gravity that is equal to a center of gravity of the subsequent sequential rotor disks;
individually determining unbalance of each selective rotor disk and each respective simulator;
calculating an un-scaled magnitude of a weight correction and a location for the weight correction on end disks of the rotor disk stack to offset vibration of each selective rotor disk when the weight correction is applied to the rotor disk stack; and
aggregating the weight corrections for each of the selective rotor disks for applying the weight corrections to the end disks in the rotor disk stack.

22. The method of claim 21, further comprising:
attaching the rotor disk stack to the shaft at the first end;
installing the rotor disk stack and the shaft into bearings within a housing;
monitoring vibration of the rotor disk stack and shaft in the gas turbine engine system; and
evaluating a need for trim balancing of the rotor disk stack and shaft.

23. The method of claim 22, wherein each rotor disk includes a plurality of blades distributed around a circumference of each rotor disk.

24. The method of claim 22, wherein each simulator has a diametral moment of polar inertia that is scaled-down from a diametral moment of polar inertia of the sequential rotor disks.

25. The method of claim 22, wherein:
the rotor disk stack includes:
a first rotor disk having a first attachment feature for connecting to the shaft;
a second rotor disk having a second attachment feature for connecting to the first rotor disk;
a third rotor disk having a third attachment feature for connecting to the second rotor disk; and
the method further comprising:
balancing the first rotor disk with a first simulator corresponding to the second rotor disk and the third rotor disk; and
balancing the second rotor disk with a second simulator corresponding to the third rotor disk.

26. The method of claim 21, further comprising balancing the respective simulators before rotating with a selective rotor disk.
